(19) United States
(12) Patent Application Publication
(10) Pub. No.: US 2016/0019609 A1
(43) Pub. Date: Jan. 21, 2016

(54) COST COMPUTATION DEVICE, COST COMPUTATION METHOD, AND COMPUTER-READABLE RECORDING MEDIUM

(71) Applicant: NEC SOLUTION INNOVATORS, LTD., Tokyo (JP)

(72) Inventor: Tohru MIYAZAKI, Tokyo (JP)

(21) Appl. No.: 14/772,789

(22) PCT Filed: Feb. 25, 2014
(86) PCT No.: PCT/JP2014/054452

§ 371 Date: Sep. 4, 2015

(30) Foreign Application Priority Data
Mar. 8, 2013 (JP) 2013-046585

(51) Int. Cl. G06Q 30/02

(52) U.S. Cl. CPC G06Q 30/0283

(57) ABSTRACT

A cost computation apparatus (10) includes: a code clone detection unit (101) that detects, as a code clone, a set of identical or similar segments of pre-modification source code of a system; a componentization level setting unit (102) that sets a level at which the detected segments are integrated as a component; a post-modification source code estimation unit (103) that estimates post-modification source code obtained by applying componentization to the pre-modification source code at the set level; and a cost computation unit (104) that computes a modification cost required to update the system and a maintenance cost on the basis of the estimated post-modification source code in accordance with a computation standard that specifies a method of computing the modification cost and the maintenance cost.

### TECHNICAL FIELD

The present invention relates to a cost computation apparatus and a cost computation method for computing the costs required for modification and maintenance in updating a system, and to a computer-readable recording medium having recorded therein a program for realizing the same.

### BACKGROUND ART

In recent years, companies are making efforts to update an old system they have been using, to a new system that operates on an open platform. In the course of such efforts, attention is drawn to a wide variety of techniques to develop a new system that executes the same processing as an old system. The feature of these techniques lies in generation of source code that realizes execution of the same processing on the basis of source code of the old system. Therefore, compared with conventional operations for system integration (SI), the number of operation processes in requirements definition and designing can be reduced. This ultimately lowers the modification cost of switching to the new system (the cost associated with designing, implementation, and testing).

In the case of an old system that has been maintained over a long period of time, its source code is often complex as a result of repetitive correction of defects, addition of functions, etc. For this reason, simply applying a system reform technique results in development of a program with low maintainability. This ultimately increases the maintenance cost of a new system (the cost associated with correction of defects and addition of functions).

On the other hand, development of highly-maintainable code requires so-called refactoring, e.g., redesigning the structure of an old system so as to simplify a program for mutual processing through componentization. An increase in the degree of such refactoring, e.g., an increase in the extent of componentization, leads to a higher modification cost and, conversely, a lower maintenance cost. This would change the cost of a new system (the sum of the modification cost and the maintenance cost). It is hence necessary to decide on the degree of refactoring that enables cost reduction through estimation of costs corresponding to the degrees of refactoring.

In general, approximate estimates of these modification cost and maintenance cost are commonly derived in accordance with the scale of software, such as the number of lines therein. For example, Patent Document 1 discloses a method of estimating a maintenance cost for a case in which maintenance of software products is undertaken by contract. The estimation method disclosed in Patent Document 1 enables estimation of the maintenance cost of software products based on the cost required to maintain various entities, and on a product model showing the influences of maintenance operations among the entities.

### LIST OF PRIOR ART DOCUMENTS

### Patent Document

Patent Document 1: JP 2007-156820A

### DISCLOSURE OF THE INVENTION

### Problems to be Solved by the Invention

However, Patent Document 1 merely discloses a method of estimating the maintenance cost, and does not disclose a method of estimating the modification cost required in transition from an old system to a new system. This gives rise to a demand for a technique that enables estimation of a modification cost and a maintenance cost while achieving optimum refactoring.

The present invention aims to provide a cost computation apparatus, a cost computation method, and a program that solve the conventional problem described above, and enable computation of a modification cost and a maintenance cost of a system, as well as estimation of the degree of refactoring that minimizes these costs.

### Means for Solving the Problems

In order to achieve the foregoing aim, a cost computation apparatus according to one aspect of the present invention is an apparatus for computing a modification cost required to update a system and a post-update maintenance cost. The cost computation apparatus includes: a code clone detection unit that detects, as a code clone, a set of identical or similar segments of pre-modification source code of the system to be updated; a componentization level setting unit that sets a level at which the segments detected as the code clone are integrated as a component; a post-modification source code estimation unit that estimates post-modification source code obtained by applying componentization to the pre-modification source code at the set level; and a cost computation unit that computes the modification cost and the maintenance cost on the basis of the estimated post-modification source code in accordance with a computation standard that specifies a method of computing the modification cost and the maintenance cost.

In order to achieve the foregoing aim, a cost computation method according to one aspect of the present invention is a method for computing a modification cost required to update a system and a post-update maintenance cost. The cost computation method includes: (a) a step of detecting, as a code clone, a set of identical or similar segments of pre-modification source code of the system to be updated; (b) a step of setting a level at which the segments detected as the code clone are integrated as a component; (c) a step of estimating post-modification source code obtained by applying componentization to the pre-modification source code at the set level; and (d) a step of computing the modification cost and the maintenance cost on the basis of the estimated post-modification source code in accordance with a computation standard that specifies a method of computing the modification cost and the maintenance cost.

In order to achieve the foregoing aim, a computer-readable recording medium according to one aspect of the present invention is a computer-readable recording medium having recorded therein a program for computing a modification cost required to update a system and a post-update maintenance cost using a computer. The program includes an instruction for causing the computer to execute: (a) a step of detecting, as a code clone, a set of identical or similar segments of pre-modification source code of the system to be updated; (b) a step of setting a level at which the segments detected as the code clone are integrated as a component; (c) a step of estimating post-modification source code obtained by applying componentization to the pre-modification source code at the set level; and (d) a step of computing the modification cost and the maintenance cost on the basis of the estimated post-modification source code in accordance with a computation standard that specifies a method of computing the modification cost and the maintenance cost.

### Advantageous Effects of the Invention

As described above, the present invention enables computation of a modification cost and a maintenance cost of a system, as well as estimation of the degree of refactoring that minimizes these costs.

### BRIEF DESCRIPTION OF THE DRAWINGS

FIG. 1 is a block diagram showing a general configuration of a cost computation apparatus according to an embodiment of the present invention.

FIG. 2 is a block diagram showing a specific configuration of the cost computation apparatus according to the embodiment of the present invention.

FIG. 3 shows an example of a code clone detected in the embodiment of the present invention.

FIG. 4 shows an example of componentization according to the embodiment of the present invention.

FIG. 5 is a flowchart showing examples of operations of the cost computation apparatus according to the embodiment of the present invention.

FIG. 6 is a flowchart showing the specifics of the cost computation processing shown in FIG. 5.

FIG. 7 is a block diagram showing an example of a computer that realizes a cost computation apparatus 10 according to the embodiment of the present invention.

FIG. 8 shows an example of a list of code clones generated in a working example of the present invention.

FIG. 9 shows an example of a computation standard used in the working example of the present invention.

FIG. 10 shows examples of pairs that are each formed by a componentization level and a cost according to the working example of the present invention.

### MODE FOR CARRYING OUT THE INVENTION

### Embodiment

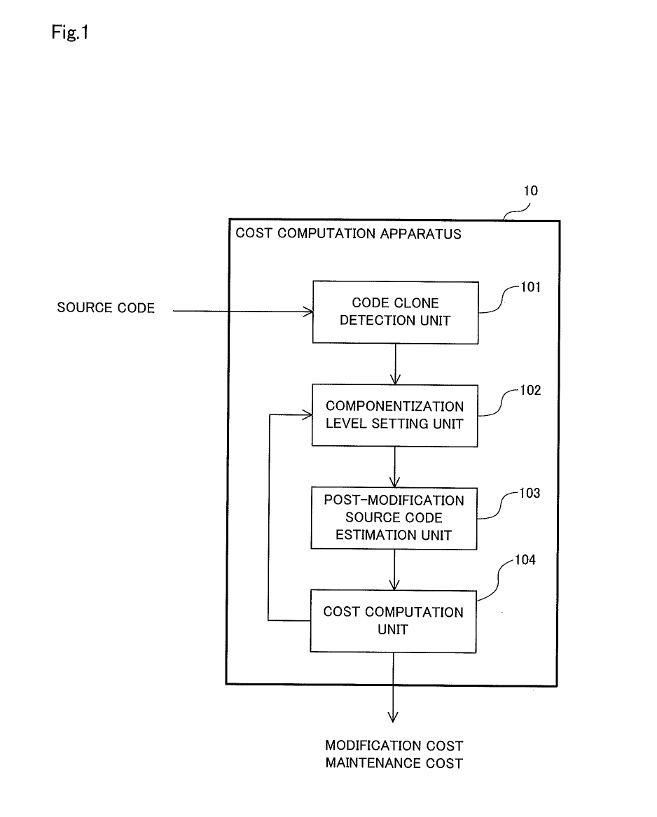

A cost computation apparatus, a cost computation method, and a program according to an embodiment of the present invention will be described below with reference to FIGS. 1 to 10.

### Example

### Configuration of Apparatus

First, a configuration of the cost computation apparatus according to the present embodiment will be described. FIG. 1 is a block diagram showing a general configuration of the cost computation apparatus according to the embodiment of the present invention.

The cost computation apparatus 10 according to the present embodiment shown in FIG. 1 is an apparatus for computing a modification cost required to update a system and a post-update maintenance cost. As shown in FIG. 1, the cost computation apparatus 10 includes a code clone detection unit 101, a componentization level setting unit 102, a post-modification source code estimation unit 103, and a cost computation unit 104.

Among these, the code clone detection unit 101 detects, as a code clone, a set of identical or similar segments of pre-modification source code of the system to be updated. The componentization level setting unit 102 sets a level at which the segments detected as the code clone are integrated as a component (hereinafter referred to as a “componentization level”).

The post-modification source code estimation unit 103 estimates post-modification source code that is obtained by applying componentization to the pre-modification source code at the set componentization level. The cost computation unit 104 computes the modification cost and the maintenance cost on the basis of the estimated post-modification source code in accordance with a computation standard that specifies a method of computing the modification cost and the maintenance cost.

As described above, the cost computation apparatus 10 can compute the modification cost and the maintenance cost of the system. Furthermore, as a componentization level indicating the degree of refactoring is set for computation of these costs by the cost computation apparatus 10, cost computation can be carried out on a level-by-level basis. Accordingly, the cost computation apparatus 10 can also estimate the degree of refactoring that minimizes these costs.

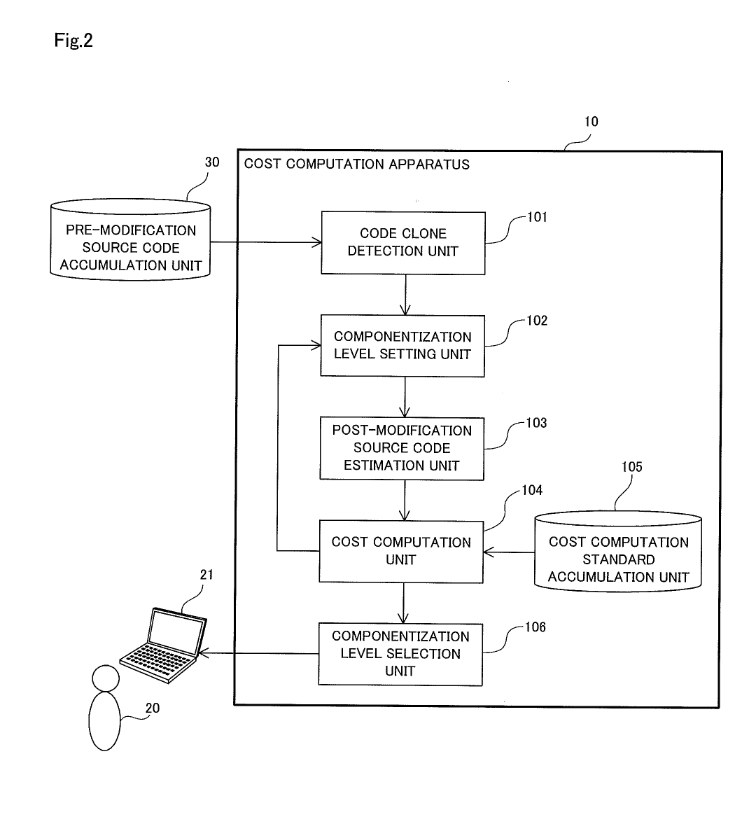

Next, the configuration of the cost computation apparatus according to the present embodiment will be described more specifically with reference to FIGS. 2 to 4. FIG. 2 is a block diagram showing a specific configuration of the cost computation apparatus according to the embodiment of the present invention.

As shown in FIG. 2, the cost computation apparatus 10 includes a cost computation standard accumulation unit 105 and a componentization level selection unit 106 in addition to the code clone detection unit 101, the componentization level setting unit 102, the post-modification source code estimation unit 103, and the cost computation unit 104. In the present embodiment, the cost computation apparatus 10 is structured by installing a program in a computer as will be described later.

Furthermore, in the present embodiment, source code targeted for cost computation is accumulated in an external pre-modification source code accumulation unit 30 as shown in FIG. 2. Alternatively, in the present embodiment, pre-modification source code may not be accumulated in the pre-modification source code accumulation unit 30 unlike the example of FIG. 1. For example, in the present embodiment, pre-modification source code may be input from a terminal apparatus 21 of a user 20 to the cost computation apparatus 10 via a communication network, such as the Internet.

In the present embodiment, “pre-modification source code” denotes source code of a system that is currently being used by a company (in other words, an old system). A “code clone” is a set of similar or matching segments of source code. One of a set of similar or matching segments constituting a code clone is referred to as a “code fraction”.

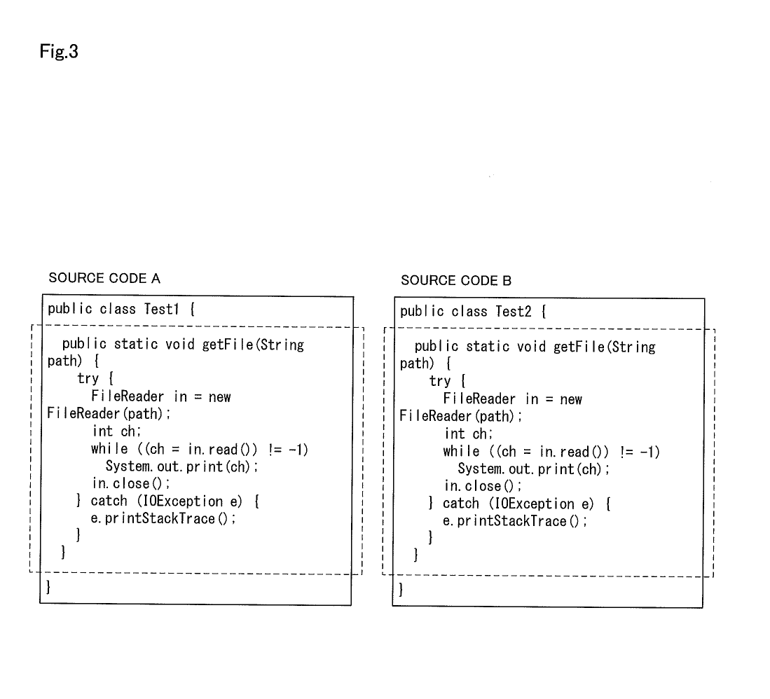

FIG. 3 shows an example of a code clone detected in the embodiment of the present invention. In the example of FIG. 3, segments enclosed by dash lines in source code A and source code B serve as a code clone. In this case, each of source code A and source code B includes one code fraction.

In the example of FIG. 3, a code clone is detected from two sequences of source code described in the Java (registered trademark) language. However, in the present embodiment, source code from which a code clone is detected is not limited to being described in the Java language.

In the present embodiment, “componentization” is processing for integrating identical or similar segments of source code that have been detected as a code clone, and refers to, for example, rewriting of code so as to allow one code fraction to call another code fraction.

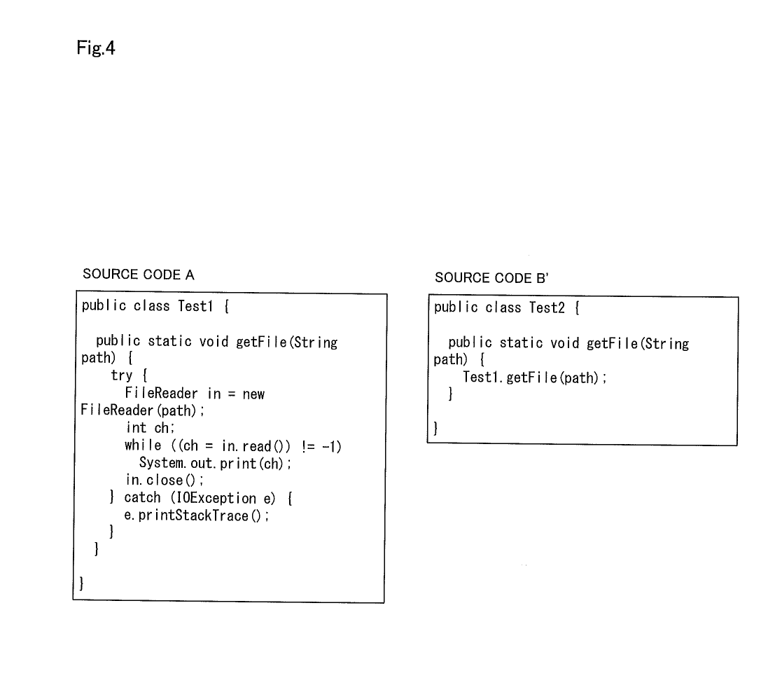

FIG. 4 shows an example of componentization according to the embodiment of the present invention. In the example of FIG. 4, componentization corrects the code fraction in source code B to call a function of the code fraction in source code A. In this way, in one example of componentization, a code fraction constituting a code clone is called through a function call.

A “componentization level” is a measure of the degree of componentization. In the present embodiment, it is a measure that defines to what extent componentization is to be applied to code clones. Specifically, the componentization level is expressed by, for example, a ratio [%] of a code clone(s) to which componentization is applied to all code clones in source code. In this case, the componentization level would be 100% if componentization is applied to all of the code clones, whereas the componentization level would be 0% if componentization is applied to none of the code clones.

In the present embodiment, “post-modification source code” denotes source code obtained by modifying pre-modification source code at a certain componentization level.

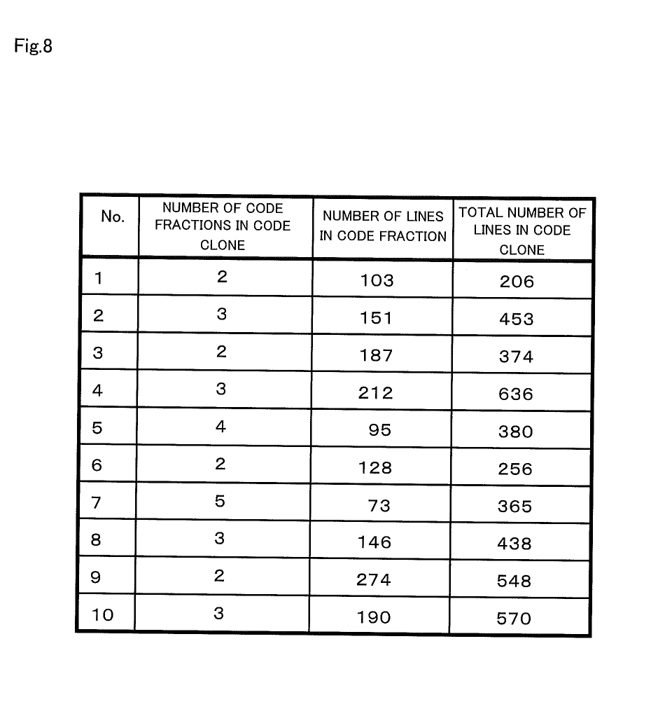

In the present embodiment, the code clone detection unit 101 acquires, from the pre-modification source code accumulation unit 30, pre-modification source code accumulated therein, and detects code clones in the pre-modification source code. The code clone detection unit 101 also generates a list of detected code clones (see FIG. 8) and transmits the list, together with the pre-modification source code, to the componentization level setting unit 103.

In the present embodiment, the code clone detection unit may be structured using a commercially available tool. Specifically, a tool described in the following reference document may be used as an example.

### REFERENCE DOCUMENT

Toshihiro Kamiya, Shinji Kusumoto, and Katsuro Inoue, “CCFinder: A Multi-Linguistic Token-based Code Clone Detection System for Large Scale Source Code,” IEEE Trans. Software Engineering, vol. 28, no. 7, pp. 654-670, (2002-7).

In the present embodiment, the componentization level setting unit 102 can set a plurality of componentization levels at any interval. For example, the componentization level setting unit 102 can set a plurality of componentization levels of 0%, 10%, 20%, . . . , and 100%. The componentization level setting unit 102 also notifies the post-modification source code estimation unit 103 of the set componentization levels, together with the pre-modification source code and the list of code clones received from the code clone detection unit 101.

In the present embodiment, the post-modification source code estimation unit 103 estimates a post-modification source record on a level-by-level basis based on the pre-modification source code, the list of code clones, and the componentization levels transmitted from the componentization level setting unit 102. The post-modification source record estimation unit 103 also transmits the estimated sequences of post-modification source code and their respective componentization levels to the cost computation unit 104.

A computation standard that specifies a method of computing a modification cost and a maintenance cost is accumulated in the cost computation standard accumulation unit 105. In the present embodiment, the cost computation unit 104 acquires the computation standard from the cost computation standard accumulation unit 105 so as to compute a modification cost and a maintenance cost.

For example, in the present embodiment, the computation standard is set based on the know-how, such as a quality standard, possessed by a company or the like that uses the cost computation apparatus 10, and is composed of an expression for computing a modification cost and an expression for computing a maintenance cost.

Specifically, one example of an expression for computing a maintenance cost is an expression for computing a modification cost by multiplying the number of components yielded through integration of segments by a set unit price. One example of an expression for computing a modification cost is an expression for computing a maintenance cost by multiplying the number of lines in the post-modification source code by a set unit price. A total sum of the cost computed by these expressions serves as a final cost.

The cost computation unit 104 also counts, in the post-modification source code, the number of units of measurement necessary for cost computation according to the computation standard. The cost computation unit 104 then applies the counted number to the computation standard so as to compute a modification cost and a maintenance cost on a per-componentization level basis. The cost computation unit 104 can further compute the sum of a modification cost and a maintenance cost. Subsequently, the cost computation unit 104 notifies the componentization level selection unit 106 of a pair formed by the computed cost and the componentization level that was set at the time of computation, on a per-componentization level basis.

The componentization level selection unit 106 identifies a componentization level corresponding to the smallest total sum of a modification cost and a host computed by the cost computation unit 104, and presents the identified componentization level and the corresponding total sum to the external user 20. That is to say, in the present embodiment, an optimum componentization level that minimizes an overall cost, including a modification cost and a maintenance cost, is automatically presented to the user 20. It should be noted that the presentation to the user 20 is carried out via, for example, his/her terminal apparatus 21.

### [Operations of Apparatus]

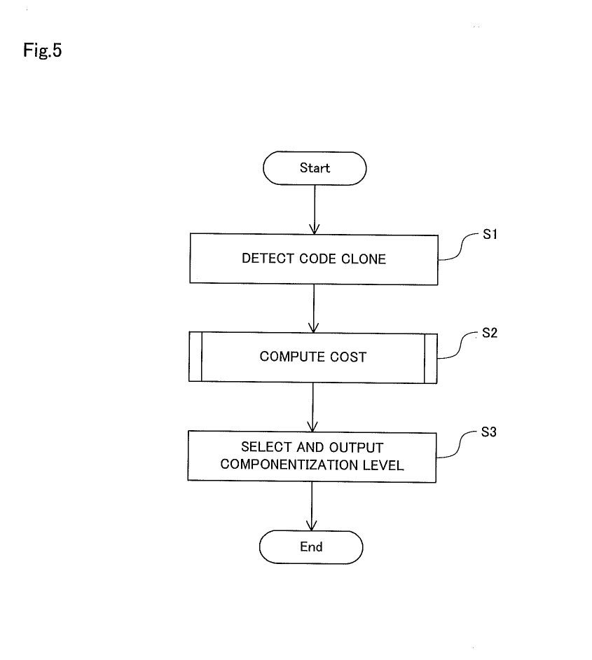

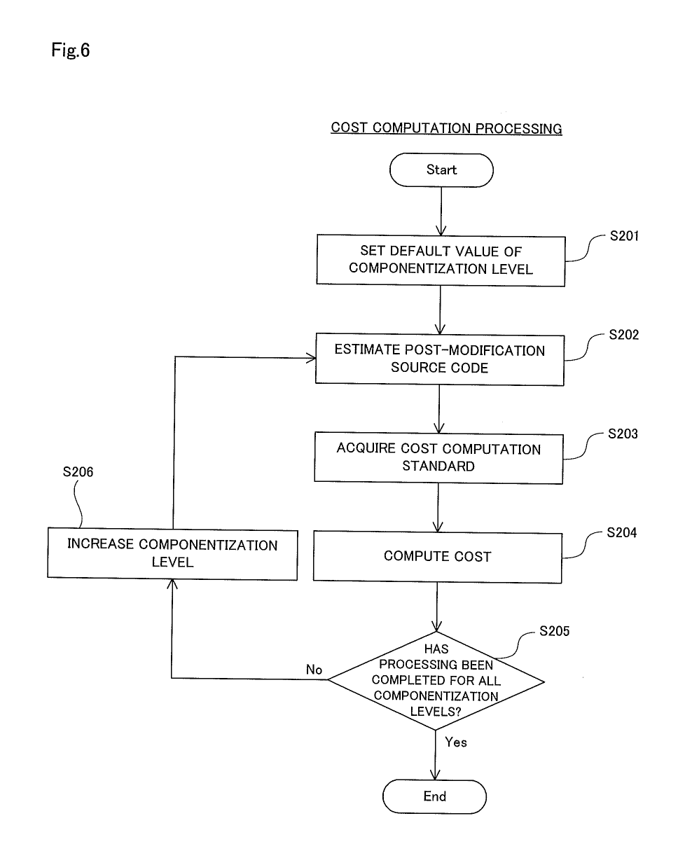

Operations of the cost computation apparatus 10 according to the embodiment of the present invention will now be described with reference to FIGS. 5 and 6. In the present embodiment, a cost computation method is implemented by causing the cost computation apparatus 10 to operate. Therefore, the following description of the operations of the cost computation apparatus applies to the cost computation method according to the present embodiment. In the following description, FIGS. 1 to 4 will be referred to as appropriate.

### [Overall Operations of Apparatus]

First, overall operations of the cost computation apparatus 10 will be described with reference to FIG. 5. FIG. 5 is a flowchart showing examples of operations of the cost computation apparatus according to the embodiment of the present invention.

As shown in FIG. 5, first, the code clone detection unit 102 acquires pre-modification source code accumulated in the pre-modification source code accumulation unit 30, and detects code clones in the pre-modification source code (step S1). In step S1, the code clone detection unit 102 also generates a list of detected code clones and transmits the list, together with the pre-modification source code, to the componentization level setting unit 103.

Next, the componentization level setting unit 102, the post-modification source code estimation unit 103, and the cost computation unit 104 execute cost computation processing (step S2). Through the execution of step S2, the cost computation unit 104 notifies the componentization level selection unit 106 of a pair formed by a computed cost and a componentization level that was set at the time of computation, on a per-componentization level basis. Step S2 will be described later with reference to FIG. 6.

Next, the componentization level selection unit 106 selects a minimum-cost pair from among the pairs notified from the cost computation unit 104, i.e., the pairs each formed by a cost and a componentization level, and presents the cost and the componentization level in the selected pair to the user 2 via the terminal apparatus 21 (step S3).

### [Operations of Apparatus Related to Cost Computation Processing]

Below, the cost computation processing shown in FIG. 5 will be described more specifically with reference to FIG. 6. FIG. 6 is a flowchart showing the specifics of the cost computation processing shown in FIG. 5.

As shown in FIG. 6, first, the componentization level setting unit 102 sets a default value of a componentization level for the processing (step S201). The componentization level setting unit 102 then passes the pre-modification source code, the list of code clones, and the set componentization level to the post-modification source code estimation unit 103.

Subsequently, the post-modification source code estimation unit 103 estimates post-modification source code by carrying out componentization, as shown in FIG. 4, in accordance with the set componentization level (step S202). The post-modification source record estimation unit 103 also transmits the estimated post-modification source code and the corresponding componentization level to the cost computation unit 104.

Specifically, in a case where the post-modification source code is not presented to the user 20 afterwards, it is sufficient only to compute the number of lines or the number of steps in the post-modification source code in estimation processing of step S202. In this case, a processing time period can be reduced.

Next, the cost computation unit 104 acquires the computation standard (see later-described FIG. 8) from the cost computation standard accumulation unit 105 (step S203).

The cost computation unit 104 then counts, in the post-modification source code transmitted from the post-modification source code estimation unit 103, the number of units of measurement necessary for cost computation according to the computation standard. The cost computation unit 104 applies the counted number to the computation standard so as to compute a modification cost and a maintenance cost corresponding to the set componentization level (step S204).

Thereafter, the cost computation unit 104 computes a total sum of the modification cost and the maintenance cost, and notifies the componentization level selection unit 106 of a pair formed by the computed total sum of costs and the set componentization level.

Next, the componentization level setting unit 103 determines whether processing has been executed for all componentization levels (step S205).

If the componentization level setting unit 103 determines in step S205 that processing has not been executed for all componentization levels yet (S205: NO), the componentization level setting unit 103 increases the value of the componentization level by a preset interval (step S206). The componentization level setting unit 103 then executes step S202 again.

On the other hand, if the componentization level setting unit 103 determines in step S205 that processing has been executed for all componentization levels (S205: YES), the componentization level setting unit 103 ends the cost computation processing. Thereafter, step S3 is executed.

### [Advantageous Effects of Present Embodiment]

As described above, in the present embodiment, a post-modification source list can be estimated. Therefore, with the use of a preset computation standard, the cost necessary for modification of source code and the cost necessary for post-modification maintenance operations can be reliably computed. An overall cost can also be computed by summing these costs.

In the present embodiment, a modification cost and a maintenance cost are automatically computed while changing a componentization level. In this way, a componentization level that minimizes the modification cost and the maintenance cost can be easily identified and presented to the user.

### Modification Examples

In the above-described example, the componentization level selection unit 106 presents only two pieces of information, that is to say, a cost and a componentization level, to the user 20. However, the present embodiment is not limited to this example. For instance, the componentization level selection unit 106 can present the content of post-modification source code to the user 20 by including the post-modification source code into a notification issued by the cost computation unit 104 to the componentization level selection unit 106.

In the above-described example, pre-modification source code and post-modification source code are described in the same programming language. However, in the present embodiment, they may be described in different programming languages. That is to say, after the pre-modification source code is input, language transformation processing may be applied to the source code.

For example, in a case where modification is applied so as to transform a system described in the COBOL language into a system described in the Java language, the cost computation apparatus 10 first receives source code described in the COBOL language as input. Then, processing of transformation into the Java language is applied. Subsequently, processing of step S1 onward is applied to the post-transformation source code. It should be noted that this language transformation processing can be executed using a commercially available tool.

### [Program]

It is sufficient for a program according to the present embodiment to cause a computer to execute steps S1 to S3 shown in FIG. 5, and steps S201 to S206 shown in FIG. 6. The cost computation apparatus 10 and the cost computation method according to the present embodiment can be realized by installing this program in the computer and executing the installed program. In this case, a central processing unit (CPU) of the computer functions as the code clone detection unit 101, the componentization level setting unit 102, the post-modification source code estimation unit 103, the cost computation unit 104, and the componentization level selection unit 106, and executes processing accordingly.

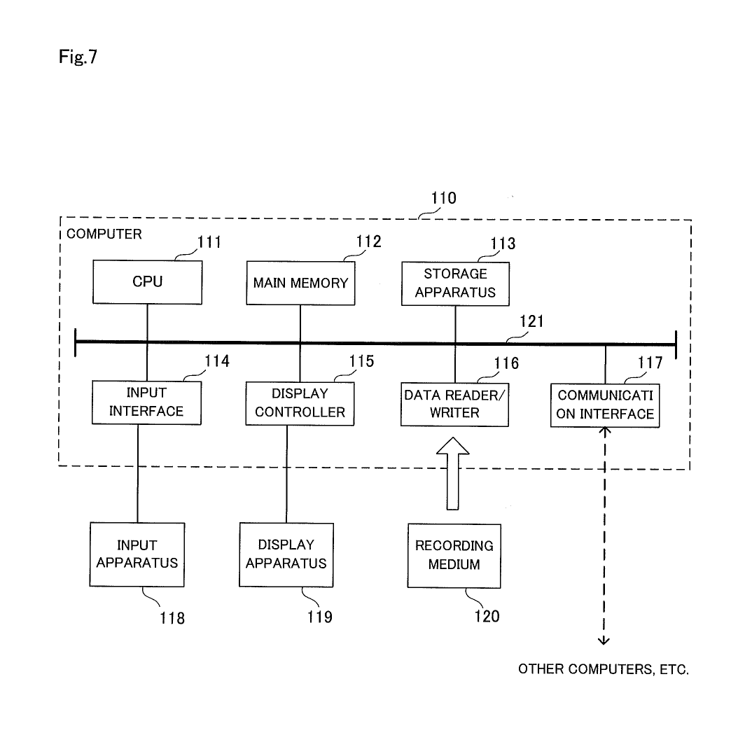

A description is now given of a computer that realizes the cost computation apparatus 10 by executing the program according to the present embodiment with reference to FIG. 7. FIG. 7 is a block diagram showing an example of a computer that realizes the cost computation apparatus 10 according to the embodiment of the present invention.

As shown in FIG. 7, a computer 110 includes a CPU 111, a main memory 112, a storage apparatus 113, an input interface 114, a display controller 115, a data reader/writer 116, and a communication interface 117. These components are connected in such a manner that they can perform data communication with one another via a bus 121.

The CPU 111 executes various types of calculation by deploying programs (code) according to the present embodiment stored in the storage apparatus 113 to the main memory 112, and executing the deployed programs in a predetermined order. The main memory 112 is typically a volatile storage apparatus, such as a dynamic random-access memory (DRAM). The programs according to the present embodiment are provided while being stored in a computer-readable recording medium 120. It should be noted that the programs according to the present embodiment may be distributed over the Internet connected via the communication interface 117.

Specific examples of the storage apparatus 113 include a hard disk and a semiconductor storage apparatus, such as a flash memory. The input interface 114 mediates data transmission between the CPU 111 and an input apparatus 118, such as a keyboard and a mouse. The display controller 115 is connected to a display apparatus 119 and controls display on the display apparatus 119.

The data reader/writer 116 mediates data transmission between the CPU 111 and the recording medium 120. The data reader/writer 116 reads the programs from the recording medium 120, and writes the result of processing in the computer 110 into the recording medium 120. The communication interface 117 mediates data transmission between the CPU 111 and other computers.

The following are specific examples of the recording medium 120: a general-purpose semiconductor storage device, such as CompactFlash (CF, registered trademark) and Secure Digital (SD); a magnetic storage medium, such as a flexible disk; and an optical storage medium, such as a compact disc read-only memory (CD-ROM).

### Working Example 1

A working example of the present invention will now be described with reference to FIGS. 8 to 10. It should be noted that the working example will be described below in line with the steps shown in FIGS. 5 and 6.

### [Step S1]

First, pre-modification source code is input to the cost computation apparatus 10. The code clone detection unit 105 then detects code clones and generates a list of detected code clones. It is assumed that, in the present working example, source code including a total of ten thousand lines is input as the pre-modification source code.

The list of code clones generated in step S1 is shown in FIG. 8. FIG. 8 shows an example of the list of code clones generated in the working example of the present invention. As shown in FIG. 8, in the list of code clones, the following are registered for each code clone detected: a number assigned to the code clone, the number of code fractions in the code clone, the number of lines in a code fraction, and the total number of lines in the code clone.

### [Step S2 (S201 to S206)]

Subsequently, the cost computation processing is executed. First, the componentization level setting unit 102 sets 0% as a default value of a componentization level (step S201).

Next, the post-modification source code estimation unit 103 estimates post-modification source code corresponding to the componentization level of 0% (step S202). Here, as the componentization level is 0%, the post-modification source code estimation unit 103 estimates post-modification source code without carrying out componentization.

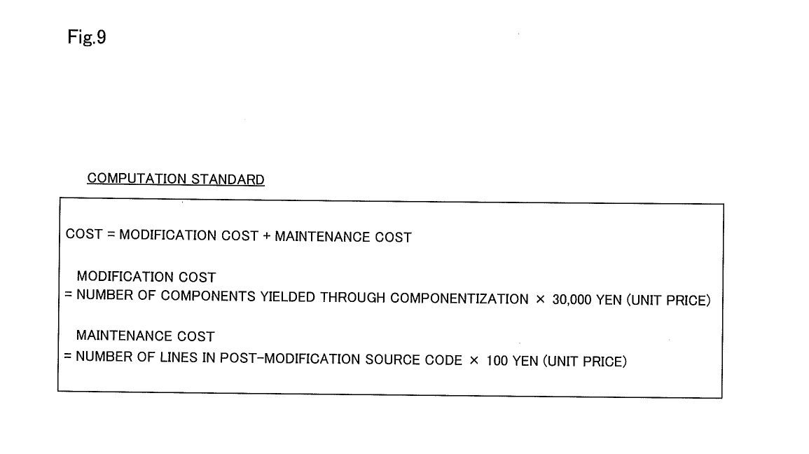

Next, the cost computation unit 104 acquires a computation standard shown in FIG. 9 from the cost computation standard accumulation unit 105 (step S203). FIG. 9 shows an example of the computation standard used in the working example of the present invention. In the example of FIG. 9, “cost=modification cost+maintenance cost” is indicated as the computation standard. The computation standard shown in FIG. 9 also indicates that the modification cost is computed as “the number of components yielded through componentization×thirty thousand yen (unit price)”, and that the maintenance cost is computed as “the number of lines in post-modification source code×one hundred yen (unit price)”.

Next, the cost computation unit 104 computes a cost in accordance with the computation standard acquired from the cost computation standard accumulation unit 105, and notifies the componentization level selection unit 106 of a pair formed by the computed cost and the componentization level (step S204).

Specifically, the modification cost is “the number of components yielded through componentization×thirty thousand yen”. However, as the componentization level is 0%, that is to say, as the post-modification source code is estimated without carrying out componentization, the modification cost is zero yen. On the other hand, the maintenance cost is “the number of lines in post-modification source code×one hundred yen”. However, as the componentization level is 0%, the number of lines in the post-modification source code is equal to the number of lines in the pre-modification source code. Therefore, the maintenance cost is ten thousand lines×one hundred yen=one million yen.

Accordingly, a cost corresponding to the componentization level of 0% is a total sum of the modification cost and the maintenance cost, i.e., one million yen (=zero yen+one million yen). The componentization level selection unit 106 is notified of a pair formed by the computed cost, which is obtained in the above-described manner, and the componentization level.

Next, the componentization level setting unit 102 determines whether processing has been executed for all componentization levels (step S205). Here, processing has not been executed for all componentization levels yet. Therefore, the componentization level setting unit 103 changes the componentization level to 10% for the next processing (step S206), and executes step S202 again.

Next, the post-modification source code estimation unit 103 estimates post-modification source code corresponding to the componentization level of 10% (step S202). Here, as the componentization level is 10%, the post-modification source code estimation unit 103 applies componentization to only 10% of the code clones shown in FIG. 9, in descending order of the number of lines therein. In the example of FIG. 9, as there are 10 code clones, componentization is applied to a code clone assigned number 4, which has the largest total number of lines.

Specifically, componentization of a code clone is carried out as follows. First, only one of code fractions in a code clone is left. The rest of the code fractions have no line as a result of componentization. That is to say, after componentization, the total number of lines in a code clone is equal to the number of lines in one code fraction. Therefore, in a case where componentization has been applied to the code clone assigned number 4, the total number of lines in the code clone after componentization is 212 lines.

Here, the number of lines in the post-modification source code is obtained by subtracting the number of lines that have been deleted from the total number of lines in the pre-modification code clone through componentization. That is to say, through componentization of the code clone assigned number 4, the number of lines therein is reduced from 636 lines to 212 lines. Accordingly, the number of lines in the post-modification source code is 10,000 lines−(636 lines−212 lines)=9,576 lines.

Next, the cost computation unit 104 acquires the computation standard shown in FIG. 9 from the cost computation standard accumulation unit 105 (step S203). The cost computation unit 104 then computes a modification cost and a maintenance cost, as well as a total sum of these costs, in accordance with the acquired computation standard. Thereafter, the cost computation unit 104 notifies the componentization level selection unit 106 of a pair formed by the computed cost and the componentization level (step S204).

Specifically, as the number of components yielded through componentization is one, the modification cost is one×thirty thousand yen=thirty thousand yen. On the other hand, as the number of lines in the post-modification source code is 9,576 lines as stated earlier, the maintenance cost is 9,576 lines×100 yen=957,600 yen. Accordingly, a total sum of the costs corresponding to the componentization level of 10% is 987,600 yen (=modification cost+maintenance cost=30,000 yen+957,600 yen).

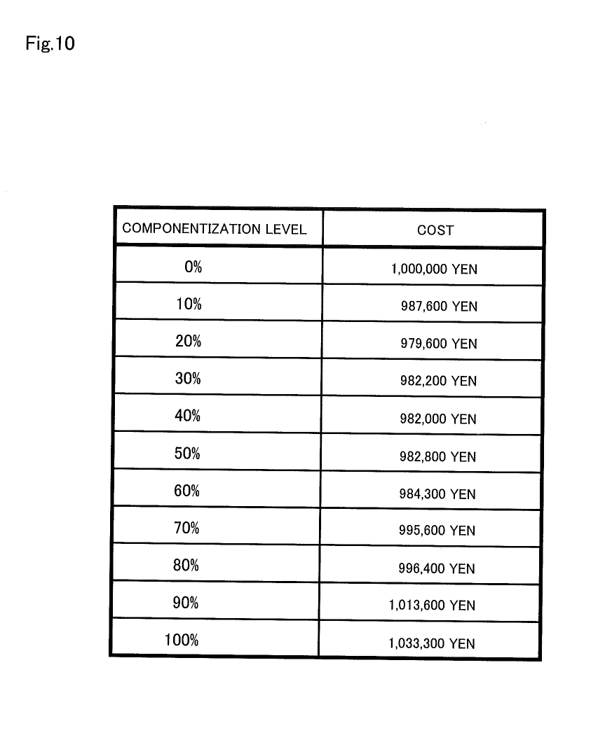

From then on, processing of steps S202 to S206 is repeated until the componentization level reaches 100%. The results of cost computation achieved by changing the componentization level from 0% to 100% at an interval of 10% are paired with the corresponding componentization levels as shown in FIG. 10. FIG. 10 shows examples of pairs that are each formed by a componentization level and a cost according to the working example of the present invention.

### [Step S3]

Thereafter, the componentization level selection unit 106 selects a minimum-cost pair from among the pairs notified from the cost computation unit 104, i.e., the pairs each formed by a cost and a componentization level, and presents the cost and the componentization level in the selected pair to the user 20 via the terminal apparatus 21.

In the present working example, the minimum-cost pair, that is to say, the pair formed by a componentization level of 40% and a cost of 982,000 yen is selected from among the content shown in FIG. 10, and presented to the user 20.

Through the execution of steps S1 to S3 according to the present working example described above, the cost necessary for modification of source code and the cost necessary for post-modification maintenance operations are computed, and a componentization level that minimizes the costs is presented to the user.

In the above-described working example, the number of lines in a code clone after componentization is computed under the assumption that, as a result of componentization, only one of code fractions in the code clone is left, and the rest of the code fractions have no line. However, the present working example is not limited in this way. The number of lines in a code clone after componentization may be computed with more precise identification of sections including duplicate code fractions. Furthermore, source code serving as the result of componentization may be generated using a commercially available tool.

The present invention has been described above using a preferred embodiment and working example. However, the present invention is not necessarily limited to the above-described embodiment and working example, and may be implemented with various modifications within a scope of technical ideas of the present invention. In addition, the above-described apparatus configurations and flowcharts are examples, and can be changed or modified in any way.

A part or all of the above-described embodiment and working example can be described as, but are not limited to, the following supplementary notes 1 to 15.

### (Supplementary Note 1)

A cost computation apparatus for computing a modification cost required to update a system and a post-update maintenance cost, the cost computation apparatus comprising:

a code clone detection unit that detects, as a code clone, a set of identical or similar segments of pre-modification source code of the system to be updated;

a componentization level setting unit that sets a level at which the segments detected as the code clone are integrated as a component;

a post-modification source code estimation unit that estimates post-modification source code obtained by applying componentization to the pre-modification source code at the set level; and

a cost computation unit that computes the modification cost and the maintenance cost on the basis of the estimated post-modification source code in accordance with a computation standard that specifies a method of computing the modification cost and the maintenance cost.

### (Supplementary Note 2)

The cost computation apparatus according to supplementary note 1,

wherein the componentization level setting unit sets a plurality of levels,

the post-modification source code estimation unit estimates the post-modification source code on a level-by-level basis, and

the cost computation unit computes the modification cost and the maintenance cost on the level-by-level basis.

### (Supplementary Note 3)

The cost computation apparatus according to supplementary note 2, further comprising

a componentization level selection unit that identifies a level corresponding to a minimum total sum of the calculated modification cost and host, and presents the identified level and the corresponding total sum to the outside.

### (Supplementary Note 4)

The cost computation apparatus according to any one of supplementary notes 1 to 3,

wherein the post-modification source code estimation unit estimates, as the post-modification source code, the number of lines or the number of steps in the post-modification source code.

### (Supplementary Note 5)

The cost computation apparatus according to any one of supplementary notes 1 to 4,

wherein according to the computation standard, the modification cost is computed by multiplying the number of components yielded through integration of segments by a first unit price, and the maintenance cost is computed by multiplying the number of lines in the post-modification source code by a second unit price.

### (Supplementary Note 6)

A cost computation method for computing a modification cost required to update a system and a post-update maintenance cost, the cost computation method comprising:

(a) a step of detecting, as a code clone, a set of identical or similar segments of pre-modification source code of the system to be updated;

(b) a step of setting a level at which the segments detected as the code clone are integrated as a component;

(c) a step of estimating post-modification source code obtained by applying componentization to the pre-modification source code at the set level; and

(d) a step of computing the modification cost and the maintenance cost on the basis of the estimated post-modification source code in accordance with a computation standard that specifies a method of computing the modification cost and the maintenance cost.

### (Supplementary Note 7)

The cost computation method according to supplementary note 6,

wherein a plurality of levels are set in step (b),

the post-modification source code is estimated on a level-by-level basis in step (c), and

the modification cost and the maintenance cost are computed on the level-by-level basis in step (d).

### (Supplementary Note 8)

The cost computation method according to supplementary note 7, further comprising
(e) a step of identifying a level corresponding to a minimum total sum of the calculated modification cost and host, and presenting the identified level and the corresponding total sum to the outside.

### (Supplementary Note 9)

The cost computation method according to any one of supplementary notes 6 to 8,

wherein in step (c), the number of lines or the number of steps in the post-modification source code is estimated as the post-modification source code.

### (Supplementary Note 10)

The cost computation method according to any one of supplementary notes 6 to 9,

wherein according to the computation standard used in step (d), the modification cost is computed by multiplying the number of components yielded through integration of segments by a first unit price, and the maintenance cost is computed by multiplying the number of lines in the post-modification source code by a second unit price.

### (Supplementary Note 11)

A computer-readable recording medium having recorded therein a program for computing a modification cost required to update a system and a post-update maintenance cost using a computer, the program including an instruction for causing the computer to execute:

(a) a step of detecting, as a code clone, a set of identical or similar segments of pre-modification source code of the system to be updated;

(b) a step of setting a level at which the segments detected as the code clone are integrated as a component;

(c) a step of estimating post-modification source code obtained by applying componentization to the pre-modification source code at the set level; and

(d) a step of computing the modification cost and the maintenance cost on the basis of the estimated post-modification source code in accordance with a computation standard that specifies a method of computing the modification cost and the maintenance cost.

### (Supplementary Note 12)

The computer-readable recording medium according to supplementary note 11,

wherein a plurality of levels are set in step (b),

the post-modification source code is estimated on a level-by-level basis in step (c), and

the modification cost and the maintenance cost are computed on the level-by-level basis in step (d).

### (Supplementary Note 13)

The computer-readable recording medium according to supplementary note 12,

wherein the instruction included in the program further causes the computer to execute (e) a step of identifying a level corresponding to a minimum total sum of the calculated modification cost and host, and presenting the identified level and the corresponding total sum to the outside.

### (Supplementary Note 14)

The computer-readable recording medium according to any one of supplementary notes 11 to 13,

wherein in step (c), the number of lines or the number of steps in the post-modification source code is estimated as the post-modification source code.

### (Supplementary Note 15)

The computer-readable recording medium according to any one of supplementary notes 11 to 14,

wherein according to the computation standard used in step (d), the modification cost is computed by multiplying the number of components yielded through integration of segments by a first unit price, and the maintenance cost is computed by multiplying the number of lines in the post-modification source code by a second unit price.

Although the invention of the present application has been described above using the embodiment and working example, the invention of the present application is not limited to the above-described embodiment and working example. The configurations and details of the invention of the present application may be subject to various changes that can be understood by a person skilled in the art within a scope of the invention of the present application.

The present application claims the benefit of priority from Japanese Patent Application No. 2013-046585, filed Mar. 8, 2013, the disclosure of which is incorporated herein by reference in its entirety.

### INDUSTRIAL APPLICABILITY

As described above, the present invention enables computation of a modification cost and a maintenance cost of a system, as well as estimation of the degree of refactoring that minimizes these costs. The present invention is useful in the efforts to update an old system to a new system that operates on an open platform.

### REFERENCE SIGNS LIST

10 cost computation apparatus
20 user
21 terminal apparatus of user
30 pre-modification source code accumulation unit
101 code clone detection unit
102 componentization level setting unit
103 post-modification source code estimation unit
104 cost computation unit
105 cost computation standard accumulation unit
106 componentization level selection unit
110 computer
111 CPU
112 main memory
113 storage apparatus
114 input interface
115 display controller
116 data reader/writer
117 communication interface
118 input apparatus
119 display apparatus
120 recording medium
121 bus

1. A cost computation apparatus for computing a modification cost required to update a system and a post-update maintenance cost, the cost computation apparatus comprising:
a code clone detection unit that detects, as a code clone, a set of identical or similar segments of pre-modification source code of the system to be updated;
a componentization level setting unit that sets a level at which the segments detected as the code clone are integrated as a component;
a post-modification source code estimation unit that estimates post-modification source code obtained by applying componentization to the pre-modification source code at the set level; and
a cost computation unit that computes the modification cost and the maintenance cost on the basis of the estimated post-modification source code in accordance with a computation standard that specifies a method of computing the modification cost and the maintenance cost.

2. The cost computation apparatus according to claim 1,
wherein the componentization level setting unit sets a plurality of levels,
the post-modification source code estimation unit estimates the post-modification source code on a level-by-level basis, and
the cost computation unit computes the modification cost and the maintenance cost on the level-by-level basis.

3. The cost computation apparatus according to claim 2, further comprising
a componentization level selection unit that identifies a level corresponding to a minimum total sum of the calculated modification maintenance cost and host, and presents the identified level and the corresponding total sum to the outside.

4. The cost computation apparatus according to claim 1,
wherein the post-modification source code estimation unit estimates, as the post-modification source code, the number of lines or the number of steps in the post-modification source code.

5. The cost computation apparatus according to claim 1,
wherein according to the computation standard, the modification cost is computed by multiplying the number of components yielded through integration of segments by a first unit price, and the maintenance cost is computed by multiplying the number of lines in the post-modification source code by a second unit price.

6. A cost computation method for computing a modification cost required to update a system and a post-update maintenance cost, the cost computation method comprising:
(a) a step of detecting, as a code clone, a set of identical or similar segments of pre-modification source code of the system to be updated;
(b) a step of setting a level at which the segments detected as the code clone are integrated as a component;
(c) a step of estimating post-modification source code obtained by applying componentization to the pre-modification source code at the set level; and
(d) a step of computing the modification cost and the maintenance cost on the basis of the estimated post-modification source code in accordance with a computation standard that specifies a method of computing the modification cost and the maintenance cost.

7. A computer-readable recording medium having recorded therein a program for computing a modification cost required to update a system and a post-update maintenance cost using a computer, the program including an instruction for causing the computer to execute:
(a) a step of detecting, as a code clone, a set of identical or similar segments of pre-modification source code of the system to be updated;
(b) a step of setting a level at which the segments detected as the code clone are integrated as a component;
(c) a step of estimating post-modification source code obtained by applying componentization to the pre-modification source code at the set level; and
(d) a step of computing the modification cost and the maintenance cost on the basis of the estimated post-modification source code in accordance with a computation standard that specifies a method of computing the modification cost and the maintenance cost.

8. The cost computation apparatus according to claim 2,
wherein the post-modification source code estimation unit estimates, as the post-modification source code, the number of lines or the number of steps in the post-modification source code.

9. The cost computation apparatus according to claim 3,
wherein the post-modification source code estimation unit estimates, as the post-modification source code, the number of lines or the number of steps in the post-modification source code.

10. The cost computation apparatus according to claim 2,
wherein according to the computation standard, the modification cost is computed by multiplying the number of components yielded through integration of segments by a first unit price, and the maintenance cost is computed by multiplying the number of lines in the post-modification source code by a second unit price.

11. The cost computation apparatus according to claim 3,
wherein according to the computation standard, the modification cost is computed by multiplying the number of components yielded through integration of segments by a first unit price, and the maintenance cost is computed by multiplying the number of lines in the post-modification source code by a second unit price.

12. The cost computation apparatus according to claim 4,
wherein according to the computation standard, the modification cost is computed by multiplying the number of components yielded through integration of segments by a first unit price, and the maintenance cost is computed by multiplying the number of lines in the post-modification source code by a second unit price.

13. The cost computation apparatus according to claim 8,
wherein according to the computation standard, the modification cost is computed by multiplying the number of components yielded through integration of segments by a first unit price, and the maintenance cost is computed by multiplying the number of lines in the post-modification source code by a second unit price.

14. The cost computation apparatus according to claim 9,
wherein according to the computation standard, the modification cost is computed by multiplying the number of components yielded through integration of segments by a first unit price, and the maintenance cost is computed by multiplying the number of lines in the post-modification source code by a second unit price.
